(19) United States
(12) Patent Application Publication
(10) Pub. No.: US 2024/0110044 A1
(43) Pub. Date: Apr. 4, 2024

(54) OPTICAL PROGRAMMING OF COLLOIDAL GEODES

(71) Applicant: UNM RAINFOREST INNOVATIONS, Albuquerque, NM (US)

(72) Inventors: Sang M. HAN, Albuquerque, NM (US); Sang Eon HAN, Albuquerque, NM (US); Michael FILLER, Albuquerque, NM (US); Vinothan N. MANOHARAN, Albuquerque, NM (US)

(73) Assignee: UNM RAINFOREST INNOVATIONS, Albuquerque, NM (US)

(21) Appl. No.: 18/370,989

(22) Filed: Sep. 21, 2023

Related U.S. Application Data
(60) Provisional application No. 63/376,794, filed on Sep. 23, 2022.

(51) Int. Cl. C08K 7/26; C08K 7/06; C09C 1/30; C09C 3/06

(52) U.S. Cl. CPC C08K 7/26; C08K 7/06; C09C 1/3054; C09C 3/066; C08K 2201/001; C08K 2201/011

(57) ABSTRACT

An optically responsive material including a composite matrix, and a plurality of colloidal nanowire geodes arranged within the composite matrix is disclosed. The optically responsive material has an optical resonance in at least one spectral region, such as in the ultraviolet spectral region, the infrared spectral region, the visible spectral region, or a combination thereof. The optically responsive material can include a composite matrix including a polymer, such as polyvinylidene fluoride. Each of the plurality of colloidal nanowire geodes further may include a hollow colloidal microsphere, and a nanowire coupled to an inner surface of the hollow colloidal microsphere. A method of fabricating optically responsive materials and a method of programming optically responsive materials is also described.

### REFERENCE TO RELATED APPLICATIONS

This application claims the benefit of U.S. Provisional Patent Application No. 63/376,794, filed on Sep. 23, 2022, which is hereby incorporated by reference in its entirety.

### TECHNICAL FIELD

The present teachings relate generally to colloidal geodes based on nanowires and, more particularly, to tunable nanowire geode-based colloidal materials.

### BACKGROUND

A longstanding problem in the design of optical materials is engineering the response over multiple spectral bands. Solving this problem is an important component to manufacturing functional materials for energy harvesting, thermal management, and functional coatings. Materials for radiative cooling, for example, must strongly scatter visible wavelengths while strongly absorbing (and re-radiating) mid-infrared (IR) radiation, and ultraviolet (UV)-protective coatings must absorb or reflect UV light while remaining transparent in the visible. To engineer a response in multiple bands, one must combine components that have optical resonances in different spectral regions. Because the choice of components and the way they are combined generally depend on the application, it is slow to fabricate and deploy such materials.

There is a current need for extending the palette of available materials, understanding and designing the optical response of individual materials, understanding the optical response of assemblies of such materials, exploring the fundamental limits on what optical properties can be programmed, and what emergent properties might lie with-in a given design space, while establishing proof-of-concept in application areas, such as radiative cooling, UV-protection, and spectrally tuned/tunable camouflage. The availability of materials with fully prescribed optical responses in a window spanning UV (200 nm wavelength) to IR (20 μm or longer) would enable such applications or uses.

Therefore, it is desirable to evaluate, design, and fabricate nanowire geode-based materials with fully prescribed optical responses.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

An optically responsive material is disclosed, which includes a composite matrix and a plurality of colloidal nanowire geodes arranged within the composite matrix. The optically responsive material has an optical resonance in at least one spectral region. Implementations of the optically responsive material include where the composite matrix includes a polymer, such as polyvinylidene fluoride. Each of the plurality of colloidal nanowire geodes further may include a hollow colloidal microsphere, and a nanowire coupled to an inner surface of the hollow colloidal microsphere. The plurality of colloidal nanowire geodes is present in an amount from about 0.5% to about 30% based on a total weight of the optically responsive material. The hollow colloidal microsphere may include silicon dioxide. The hollow colloidal microsphere may include silicon nitride. The nanowire may include a semiconductor material. The nanowire may include silicon, phosphorous, boron, germanium, or a combination thereof. The nanowire can be doped with one or more impurities to modify a dielectric property of the colloidal nanowire geodes. The nanowire is selectively etched to scatter light in one or more spectral regions. Each of the plurality of colloidal nanowire geodes has an optical resonance in the ultraviolet spectral region. Each of the plurality of colloidal nanowire geodes has an optical resonance in the infrared spectral region. Each of the plurality of colloidal nanowire geodes has an optical resonance in the visible spectral region. The optically responsive material has an optical resonance in the ultraviolet spectral region, the infrared spectral region, the visible spectral region, or a combination thereof.

A colloidal nanowire geode is disclosed. The colloidal nanowire geode can include a hollow colloidal microsphere, and a nanowire coupled to an inner surface of the hollow colloidal microsphere. Implementations of the colloidal nanowire geode can include where the colloidal nanowire geode has an optical resonance in at least one spectral region. The colloidal nanowire geode has an optical resonance in the ultraviolet spectral region, the infrared spectral region, the visible spectral region, or a combination thereof. The hollow colloidal microsphere may include silicon dioxide. The hollow colloidal microsphere may include silicon nitride. The nanowire may include a semiconductor material. The nanowire may include silicon, phosphorous, boron, germanium, or a combination thereof. The nanowire is doped with one or more impurities to modify a dielectric property of the colloidal nanowire geodes. The nanowire is selectively etched to scatter light in one or more spectral regions.

A method of fabricating optically responsive materials is also disclosed. The method of fabricating optically responsive materials includes emulsifying a plurality of microscapsules from a hydrophobic silica in the presence of a hydrophilic metal nanoparticle in a water-in-oil media in a first emulsification process, emulsifying the plurality of microscapsules further in a water-in-oil-in-water media in a second emulsification process to produce a double emulsion; diluting the double emulsion to extract an oil portion of the double emulsion into a water phase to create a plurality of consolidated, porous microcapsule suspension, drying the suspension to produce a plurality of hollow microcapsules having metal nanoparticles disposed onto an interior surface of the plurality of hollow microcapsules, and depositing a nanowire onto the one or more metal nanoparticles to initiate and grow a plurality of nanowires disposed onto the interior surface of the plurality of hollow microcapsules. Implementations of the method of fabricating optically responsive materials can include selectively etching the plurality of nanowires to tune an optical resonance in at least one spectral region. The method of fabricating optically responsive materials may include filling one or more pores in an exterior surface of the plurality of microscapsules by atomic layer deposition. The plurality of nanowires may include silicon, phosphorous, boron, germanium, or a combination thereof. The plurality of nanowires is doped with one or more impurities to modify a dielectric property of the plurality of nanowires. The hydrophilic metal nanoparticles may include gold.

A method of programming optically responsive materials is also disclosed. The method of programming optically responsive materials includes inputting one or more structural parameters of a colloidal nanowire geode into a finite-element model simulation to predict an optical response result of the colloidal nanowire geode, synthesizing a colloidal nanowire geode according to the inputted structural parameters, measuring optical properties of the colloidal nanowire geode, and comparing the measured properties of the colloidal nanowire geodes to the predicted optical response result. Implementations of the method of programming optically responsive materials include where the finite-element model simulation can include a radiative-transfer approach or a Monte Carlo approach.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic overview of a geode-based materials platform, in accordance with the present disclosure.

FIG. 2 is a schematic describing a process including multiple feedback loops between modeling, synthesis, assembly, theory, and characterization, in accordance with the present disclosure.

FIG. 3A is an illustration of nanowire “barcoding” with modulated doping along the nanowires and FIG. 3B is an image illustrating selective etching of “barcoded” nanowires used for visible light scattering, in accordance with the present disclosure.

FIGS. 4A-4E are plots depicting simulated extinction efficiency of the LSPR excitation for Si nanowires containing embedded doped segments with varying aspect ratios (AR), in accordance with the present disclosure.

FIG. 5 is a depiction of geode synthesis, showing microcapsule synthesis and growth of nanowires inside, in accordance with the present disclosure.

FIGS. 6A and 6B are plots depicting simulation of scattering and absorption efficiency spectra, respectively, for infinite Si nanowires of ˜10²⁰ cm⁻³ doping, in accordance with the present disclosure.

FIG. 7 is a plot depicting a simulation of scattering strength of hollow microspheres in a dielectric material with n=1.5 and at a volume fraction of 0.5, where D represents sphere diameter, in accordance with the present disclosure.

FIGS. 8A-8C depict a Monte Carlo approach for modeling optical response of assemblies of geodes, where FIG. 8A depicts a diagram of simulation, showing trajectory of a photon packet, phase function, and step size distribution, FIG. 8B depicts a rendering of trajectories from a simulation of disordered 200 nm polystyrene spheres, and FIG. 8C is a diagram of roughness scales and plot showing agreement between model and experiment when roughness is accounted for, in accordance with the present disclosure.

FIG. 9A depicts an illustration of the optical boundary layer model for the top interface of assembled geodes, while FIGS. 9B-9C depict the angular distribution of light transmitted through a photonic glass and scattered into air and borosilicate glass, respectively, in accordance with the present disclosure.

FIGS. 10A-10C are SEM images of D=2 μm silica microspheres deposited by spray coating when the surfactant concentration is 0%, 2×10⁻⁴%, and 2×10⁻³%, respectively, where the scale bar represents 20 μm. FIG. 10D is a plot depicting an l* spectrum for the 3 cases, where solid lines show theoretical values and dots show experimental values, in accordance with the present disclosure.

FIG. 11A is an image depicting the incorporation of hollow microspheres into polymer matrices while FIG. 11B is a plot of a reflectance spectrum of a silicone coating embedded with hollow styrene acrylic polymer microspheres, commercial solar rejection paint, and 6061 aluminum alloy, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure is directed to an enabling platform that provides: (1) an unprecedented combination of optical programmability and ease of fabrication: given a target optical response, it will be possible to specify a material structure that has the desired response, to fabricate it at scale, and to incorporate it into a functional material or device; (2) an understanding of the fundamental limits on what optical properties can be programmed in this hierarchical platform, and the new and unexpected properties that lie within the design space. The present teachings provide further understanding of and ability to model optical phenomena at multiple length scales, of soft and hard, ordered and disordered materials. Moreover, the present teachings focus on the fundamental and practical limitations of linear responses, as many applications would benefit from such control over multiple spectral ranges. Furthermore, this geode platform promises a marriage of optical functionality and processability not possible in currently known methods and materials. Such a capability can impact a broad range of technologies, including exterior coatings of space vehicles for heat management, broad spectrum camouflage, and radiatively cooled rooftop coatings. The present teachings can also provide a platform for using the geode-based concepts described herein to harness, for example, nonlinear or quantum optical effects.

The present teachings provide a paradigm for making materials with programmable optical response across multiple bands simultaneously: UV, visible, and IR. The present disclosure provides the use of a single materials platform that is versatile enough to address many different applications, making rapid design and deployment possible. To achieve this vision, two overarching challenges can be solved: (1) The engineering challenge is to combine programmability with ease of fabrication: given a target optical response, it must be possible to specify a structure that has that response, to fabricate it at scale, and to incorporate it into a functional material or device; (2) The scientific challenge is to understand the fundamental limits on what properties can be programmed with the platform, and what new and unexpected properties might lie within the design space.

Nanowire geodes are hollow colloidal particles with semiconductor nanowires decorating their interior, and whose composition and structure can be effectively “programmed” with nanoscale precision to yield a desired optical response. Because geodes combine the many optical properties of nanowires with the processability of conventional colloidal particles, they constitute a versatile photonic materials platform for a range of applications. Computation is essential because the parameter space is enormous, including the nanowire doping levels and morphologies, the sizes and volume fractions of the nanowires and microcapsules, the arrangement of the geodes in the final material, and the complex dielectric functions of all the components.

There is a current need for extending the palette of geode-based materials, understanding and designing the optical response of individual geodes, understanding the optical response of assemblies of geodes, exploring the fundamental limits on what optical properties can be programmed in the platform, and what emergent properties might lie with-in the design space, and establishing proof-of-concept in application areas, such as radiative cooling, UV-protection, and spectrally tuned/tunable camouflage. The availability of nanowire geode-based materials with fully prescribed optical responses in a window spanning UV (200 nm wavelength) to IR (20 μm or longer) would enable previously mentioned applications or uses.

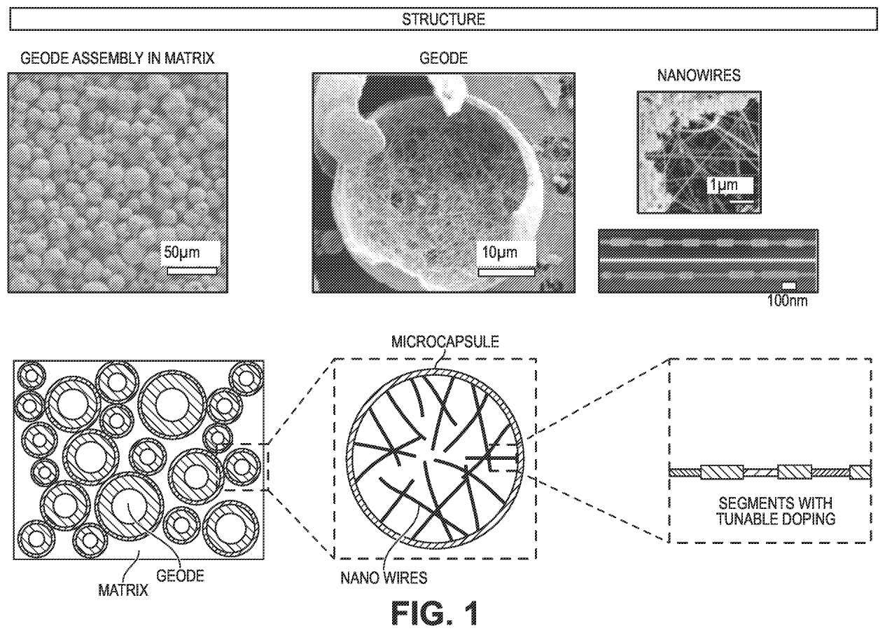

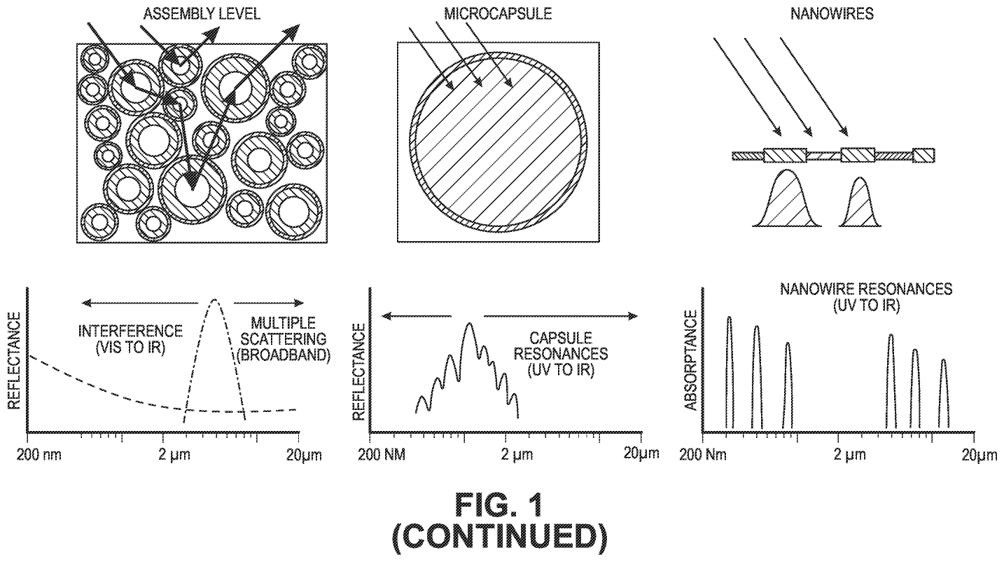

FIG. 1 depicts a schematic overview of a geode-based materials platform, in accordance with the present disclosure. The top half of FIG. 1 shows the hierarchical structure of colloidal nanowire geodes, which can be controlled from tens of nanometers to hundreds of micrometers. The bottom half of FIG. 1 shows the resonances and scattering effects that can be programmed into the material by varying the structure at different scales. A central concept relies on the understanding of how these effects couple to yield the overall response of the assembly.

To address the engineering challenge, hierarchically structured materials based on colloidal nanowire geodes (as shown in the top portion of FIG. 1), a new type of structure has been developed. A geode is a microcapsule containing nanowires. Semiconductor nanowires with nanoscale-engineered morphologies offer unparalleled control over the frequencies and widths of resonances from the UV to IR, but they are difficult to incorporate into flow processes, owing to their lack of colloidal stability and inability to be produced at scale. Conversely, colloidal microspheres are readily incorporated into flow processes and easily stabilized, but their dielectric and plasmonic resonances tend to be broad due to their spherical geometry. The geodes combine the best properties of both systems, namely, the tunability and versatility of nanowires with the processability of microspheres. Furthermore, the high internal surface area of the microcapsule enables a dense growth of nanowires and protects them after growth.

Geodes and composites thereof are structured hierarchically. Structure can be controlled at each length scale, which is critical to achieving our goal of programmability over multiple spectral bands. At the smallest scale are the nanowires, which can be grown and etched so that each nanowire has multiple segments with different doping levels, morphologies, and resonances. At the next scale are the geodes. Their microcapsules can be synthesized with different thicknesses and sizes, and the nanowires inside can be grown at different densities. At the largest scale is the composite material, consisting of many geodes. The density and arrangement of these geodes can be controlled, and a matrix material can be added. Each of these synthetic “control knobs” make orthogonal adjustments to the structure, in that the nanowire morphology can be tuned independently of the microcapsule size, for example.

However, the optical response is not orthogonal, which brings additional challenges in the development of such a system. For example, the cavity modes of the microcapsules can enhance, suppress, or augment the nanowire resonances. In assemblies of many geodes, the optical response depends on interference between waves scattered from individual nanowires and microcapsules as well as multiple scattering. Interference can give rise to additional resonances that can interact with the nanowire and cavity resonances. Multiple scattering can give rise to broad reflectance peaks in different spectral regions.

To address this scientific challenge—discovering what optical responses can be programmed and why others cannot—it can be helpful to understand the interplay between these effects. This provides further complications, particularly in the presence of multiple scattering. Computation is essential to achieving this goal because the parameter space is enormous, including the nanowire doping levels and morphologies, the sizes and volume fractions of the nanowires and microcapsules, the arrangement of the geodes in the final material, and the complex dielectric functions of all the components. But this complexity also opens the door to potentially unexpected and useful optical properties. For example, the coupling between multiple scattering and absorption allows corals to achieve nearly tenfold higher photosynthetic efficiency than terrestrial plants.

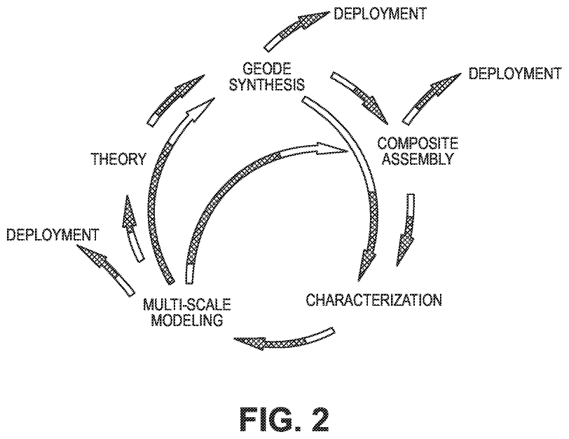

In the interest of enabling rapid discovery, design, and fabrication of geode-based materials with a prescribed optical response from the UV (200 nm wavelength) to the IR (20 μm or longer) further developmental alignment can be advantageous. Given a desired spectrum, it can be further advantageous to determine the material structure(s) that are closest to this spectrum. Where this is not possible, the physical reasons can be further studied. This aim can be aligned with four goals, as represented by the schematic in FIG. 2. FIG. 2 is a schematic describing a process including multiple feedback loops between modeling, synthesis, assembly, theory, and characterization, in accordance with the present disclosure.

Integration of experiment, computation, and theory. Ultimately, the goal is to minimize iteration between modeling and synthesis/assembly, where the ideal model is one that accurately predicts the response that the fabricated material will show. This is an achievable goal because the fundamental physical principles (Maxwell's equations) are known. Getting to an accurate and predictive model, however, will require iteration. To meet the fundamental aim of to deploy advanced materials at an accelerated pace with less cost, the computational approach must be efficient, which means approximations made should be tested in experiment. Furthermore, the scientific goal of discovering the fundamental limits on what responses are possible requires developing simplified, explanatory theories based on exploring the design space. FIG. 2 shows the feedback loop between computation, theory, characterization, synthesis, and assembly.

The integration of nanowire synthesis and characterization, colloids and emulsion templating, synthesis and characterization of hierarchically structured materials, and computational modeling of light-matter interactions combined with expertise and experimentation in different application areas, including radiative heat management, thermal emission, and structural color can further support the aforementioned goals.

As such, the major technical aims are to extend the palette of geode-based materials by developing new techniques for making geodes with controllable size and shell thickness and with different types of nanowires inside; to understand the optical response of individual geodes by developing models that describe the coupling between resonances at the nanowire and microcapsule scales and validating the models by comparison with experiment; to understand the optical response of assemblies of geodes by developing and validating models for multiple scattering and interference in assemblies of geodes; to explore the limits of what optical responses are possible by using the models developed to explore what optical responses can be programmed, given what is possible to synthesize; and further establishing proof of concept of these stated goals.

The development of theoretical models that explain limitations and tradeoffs in the geode platform can be generated, for example, given a particular coating thickness, determining a maximum possible radiative cooling achievable in the geode system, understanding the physics (e.g., Kramers-Kronig, multiple scattering) that governs this limit. Additionally, in a UV-protective coating, understanding a tradeoff between visible transparency and UV opacity, and what new emergent properties (e.g., absorption enhancement) may arise from the interplay of multiple scattering with the resonances. Once this is established as a proof of concept, methods for assembling geodes can be developed and, in concert with modeling and constrained optimization, used to build optimal geode-based structures for applications such as radiative cooling, UV protection, and broad-spectrum camouflage.

Semiconductor nanowires have arguably the most programmable optical response of any material system, but leveraging this versatility to make materials at scale is a difficult challenge. The geode platform addresses only part of that challenge, providing a way to make large quantities of nanowires and protect them. Further progress requires the understanding of how nanowires interact optically with the other components of the assembly. More broadly, the geode-based platform offers a compelling opportunity to explore fundamental and practical limitations of linear multispectral response.

### Nanowire Synthesis

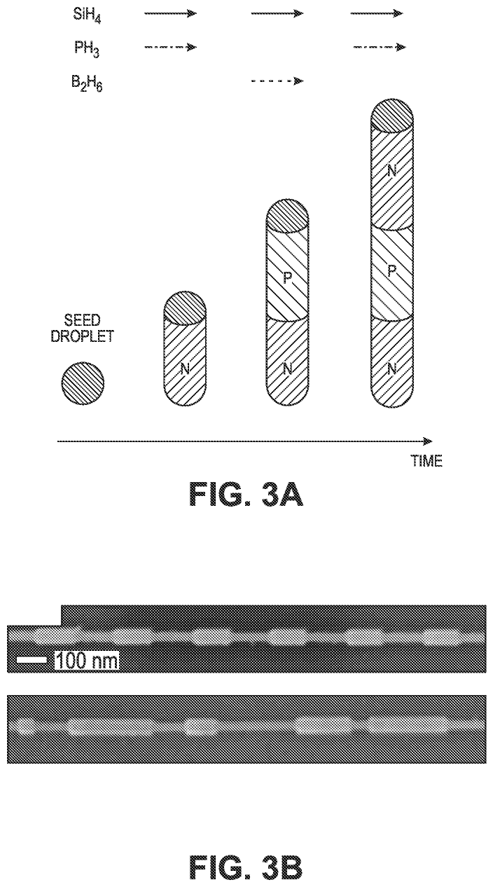

FIG. 3A is an illustration of nanowire “barcoding” with modulated doping along the nanowires and FIG. 3B is an image illustrating selective etching of “barcoded” nanowires used for visible light scattering, in accordance with the present disclosure. The metal-seeded vapor-liquid-solid (VLS) mechanism permits the bottom-up growth of single-crystal semiconductor nanowires. The principle is illustrated in FIG. 3A, showing where vapor phase precursors (e.g., silane, phosphine, and diborane) decompose at a liquid seed droplet and deposit atomic species (e.g., Si, P, and B) inside the seed droplet that then choreographs the crystallization of the solid nanowire (e.g., phosphorus- or boron-doped Si). Nanowire elongation results from nucleation near the tri-junction and step-flow as additional precursors arrive. Central to the potential and versatility of VLS growth is the ability to “barcode” or “program” functional blocks along the nanowire length by modifying growth conditions as a function of time. Segments of different doping levels and materials are possible, creating a rich palette from which to engineer nanowire properties. It is possible to further control structure after nanowire growth. As seen in FIG. 3B, dopant barcoding is combined with a post-synthesis selective KOH etch enabling precisely tunable nanoscale morphologies.

### Nanowire Optics

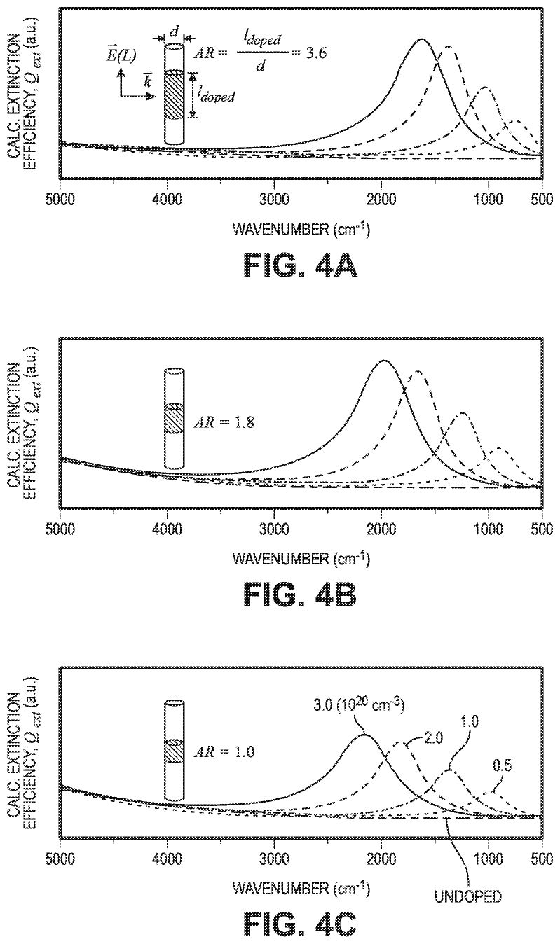

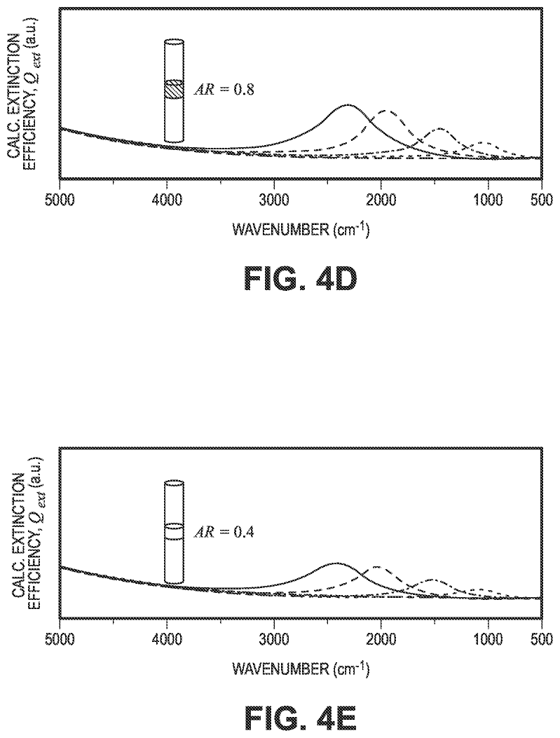

FIGS. 4A-4E are plots depicting simulated extinction efficiency of the LSPR excitation for Si nanowires containing embedded doped segments with varying aspect ratios (AR), in accordance with the present disclosure. The nanoscale structural and compositional control possible in VLS-grown semiconductor nanowires makes them ideal platforms for engineering a range of optical phenomena. Mie resonances in the visible are routinely observed in nanowires due to their nanoscale diameter, which, at the most basic level, can be adjusted via seed nanoparticle size. The large dielectric constant and cylindrical geometry of nanowires can also support, for example, leaky modes that allow for further spectral engineering. Of particular importance in the present teachings, VLS growth combined with post-synthetic etching, as shown in each inset of the plots shown in FIGS. 4A-4E allows individual nanowires to support multiple Mie resonances, dramatically expanding the design space. The AR is denoted as l_{doped}/d within each inset diagram. Tuning nanowire dielectric properties via impurity doping (e.g., B or P in Si nanowires) opens the door to mid-IR localized surface plasmon resonances (see FIG. 4). While group IV semiconductors are indirect band gap materials, the direct band gap of III-V nanowires, especially when combined with nanoscale barcoding possible with VLS growth, can enable lasers, light emitting diodes, single photon light sources, and more.

### Geode Synthesis

Nanowire geodes are microcapsules with semiconductor nanowires filling their interior. In many ways, they are analogous to natural geodes—hollow rocks whose inner surface serves as a site for the nucleation and growth of crystalline minerals. Microcapsules are synthesized from silica particles via a double-emulsion-solvent-extraction scheme, drying, and calcination. The interior surface of the microcapsules is lined with metal nanoparticles that seed nanowire growth via the VLS mechanism. A microcapsule powder is then placed inside a chemical vapor deposition (CVD) reactor, where gaseous growth precursors diffuse through the porous microcapsule wall, decompose at the metal nanoparticles, resulting in nanowire growth. FIG. 1 shows an embodiment of geodes containing dopant-modulated Si nanowires that can be used in the present teachings.

Thus, the present teachings provide an optically responsive material made of a composite matrix, and a plurality of colloidal nanowire geodes arranged within the composite matrix, such that the optically responsive material has an optical resonance in at least one spectral region. The composite matrix can include a polymer, such as polyvinylidene fluoride, silicone, or others. In examples, each of the plurality of colloidal nanowire geodes further can include a hollow colloidal microsphere, and a nanowire coupled to an inner surface of the hollow colloidal microsphere. In other examples, the plurality of colloidal nanowire geodes is present in an amount from about 0.5% to about 30% based on a total weight of the optically responsive material. The hollow colloidal microsphere can include silicon dioxide, silicon nitride, combinations thereof or others. Nanowire material can include semiconductor materials, such as, but not limited to silicon, phosphorous, boron, germanium, or a combination thereof. In examples, these nanowires can be doped with one or more impurities to modify a dielectric property of the colloidal nanowire geodes. The nanowire is selectively etched, modified, or tailored to scatter light in one or more spectral regions, such as but not limited to the ultraviolet, infrared, visible, or a combination of the aforementioned spectral regions. Thus, the plurality of colloidal nanowire geodes has an optical resonance in these regions as well. The optically responsive material can include a colloidal nanowire geode including the materials or properties mention herein.

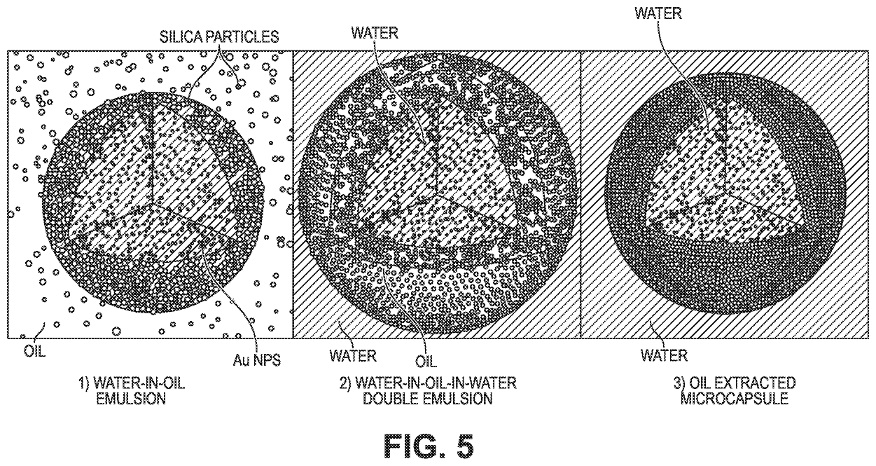

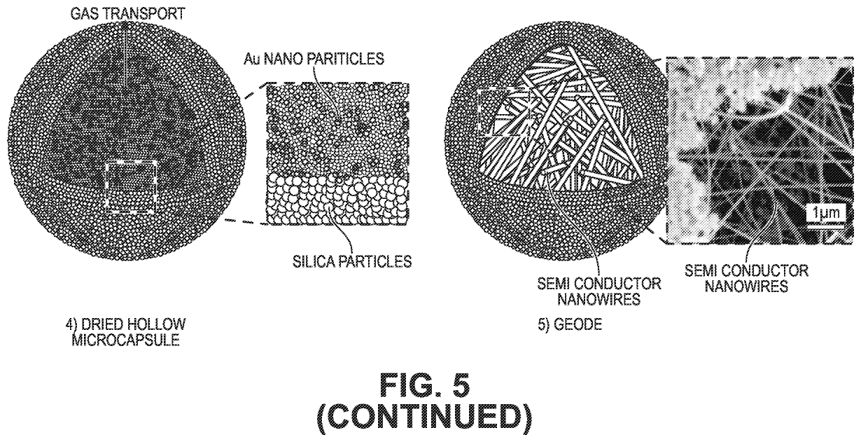

FIG. 5 is a depiction of geode synthesis, showing microcapsule synthesis and growth of nanowires inside, in accordance with the present disclosure. The steps for producing hollow microcapsules via emulsion templating are outlined in FIG. 5. An initial emulsification results in a water-in-oil emulsion with hydrophilic metal nanoparticles (that will ultimately seed and catalyze nanowire growth) dispersed in the aqueous droplet phase, and with hydrophobic silica particles (that will ultimately form the microcapsule shell) in the continuous oil phase (panel 1). A second emulsification yields a water-in-oil-in-water double emulsion (panel 2). The oil, which is partially soluble in water, is then extracted into the water phase upon further dilution (panel 3). During this extraction step, the silica particles in the oil consolidate to form the porous microcapsule wall. The suspension is dried to yield hollow microcapsules decorated with metal nanoparticles on their interior surfaces (panel 4). After calcination, the microcapsules are ready for nanowire growth (panel 5). Selection of wall nanoparticle type and size enables tuning of the chemical, mechanical, and transport properties of the microcapsules to meet specific process requirements.

The present teachings described herein establishes two essential prerequisites: (1) the optical resonances of semiconductor nanowires can be programmed precisely over a wide spectral range; and (2) the nanowires can be grown inside spherical microcapsules to make geodes. There remain several open problems. The optical response of individual geodes—as well as assemblies of such—must be modeled and characterized. The toolkit for synthesizing geodes must be expanded to control the size and polydispersity of the microcapsules, as well as the structure and density of the nanowires within. New methods are also needed to assemble geodes in a matrix phase. After addressing these problems, the limits of the possible optical responses can be studied and this knowledge used to design optimal materials for applications.

### Extending the Palette of Geode-Based Materials

A combination of existing capabilities will be completed to (i) synthesize geodes containing dopant-modulated nanowires, as previously shown in FIG. 1, and (ii) selectively etch (using KOH) the same type of nanowires on planar substrates to yield the desired, optically-active grooves on nanowires inside geodes. The etching process must enable efficient KOH transport through the pores of the geode wall and also etch the undoped Si nanowire segments to the desired depth. Fortunately, the rate at which KOH etches undoped Si is ˜100× faster than silica. However, the presence of the geode wall may be nonnegligible. Because the silica particles forming the geode wall are connected only by nanoscale silica bridges (following calcination), even short KOH etching could break these bridges, resulting in geode wall degradation and dissolution. A number of solutions to such a problem, should it arise, are available: (i) geode calcination (prior to or after nanowire growth) can increase the size of or densify the silica bridges, increasing their robustness to KOH; (ii) a selective silica surface functionalization or atomic layer deposition (ALD) process can be used to passivate the silica against KOH etching; (iii) hollow microcapsules could be synthesized using an alternative particle material (e.g., silicon nitride) that is more resistant to KOH etching.

The proposed optical programming will also require: (1) tuning geode dimensions (overall diameter, wall thickness) and internal nanowire density to generate the structures predicted from modelling, (2) “sealing” geodes against polymer infiltration, (3) independently engineering grooves and doping to simultaneously control both UV/visible and IR properties.

Geode diameter and wall thickness are set during the emulsion templating process and can be controlled via parameters such as particle weight fraction, surfactant weight fraction, and homogenization speed. While the density of dopant-modulated Si nanowires inside current geodes (2-5%) is already sufficient for the proposed work, nanowire density can be adjusted via Au nanoparticle density during emulsification.

Methods for fabricating optically responsive materials as provided herein include emulsifying a plurality of microscapsules from a hydrophobic silica in the presence of a hydrophilic metal nanoparticle in a water-in-oil media in a first emulsification process, emulsifying the plurality of microscapsules further in a water-in-oil-in-water media in a second emulsification process to produce a double emulsion, diluting the double emulsion to extract an oil portion of the double emulsion into a water phase to create a plurality of consolidated, porous microcapsule suspension, drying the suspension to produce a plurality of hollow microcapsules having metal nanoparticles disposed onto an interior surface of the plurality of hollow microcapsules, and depositing a nanowire onto the one or more metal nanoparticles to initiate and grow a plurality of nanowires disposed onto the interior surface of the plurality of hollow microcapsules. Examples of the methods of fabricating optically responsive materials can include selectively etching the plurality of nanowires to tune an optical resonance in at least one spectral region, or filling one or more pores in an exterior surface of the plurality of microscapsules by atomic layer deposition. In examples, the hydrophilic metal nanoparticles comprises gold. These optically responsive materials can be programmed by inputting one or more structural parameters of a colloidal nanowire geode into a finite-element model simulation to predict an optical response result of the colloidal nanowire geode, synthesizing a colloidal nanowire geode according to the inputted structural parameters, measuring optical properties of the colloidal nanowire geode, and comparing the measured properties of the colloidal nanowire geodes to the predicted optical response result. The finite-element model simulation can include a radiative-transfer approach or a Monte Carlo approach.

The synthesis process may be adapted to make smaller as well as more monodisperse geodes. The current approach for making geodes is efficient and scalable, but it works best for making geodes that are tens of micrometers, and it results in a polydisperse distribution. Interference effects and microcapsule resonances have broad peaks that occur at wavelengths comparable to the size of the capsule. To be able to tune these peaks throughout the visible and IR, capsules in the 1-10 μm range, or even smaller, are desired. The use of porous glass membranes, an established technique, can produce double emulsions with droplet diameters less than 10 μm. Incorporating silica or other nanoparticles inside the oil phase may lead to clogging, in which case different particle sizes, concentrations, and stabilizing agents can be explored to mitigate the problem. In parallel, the use of microfluidic methods can be used to reduce the polydispersity of geodes. These methods result in large (100-500 μm) droplets with low polydispersity, but the sizes can be reduced by subsequent application of the porous glass membrane technique. The resulting monodisperse geodes will be useful for applications in which the resonances of the microcapsules need to be precisely controlled or need to couple strongly to the nanowire resonances.

Maintaining a nanowire-air interface is important for many optical properties. While a porous microcapsule wall is essential for efficient precursor transport during nanowire growth, it can also allow for unwanted polymer infiltration upon composite formation. To prevent such infiltration, atomic layer deposition (ALD) can provide a route to “seal” geodes. ALD's self-limiting nature allows it to uniformly coat highly porous structures until pores are completely filled and precursor transport ceases. The choice of material can be dependent on the availability of ALD processes and its impact on the geode/composite optical properties. Materials used for this purpose can include Al₂O₃, TiO₂, ZrO₂, and HfO₂.

Broad multispectral optical programming will ultimately require simultaneous control of nanowire groove dimensions as well as local carrier density. These parameters are strongly coupled in the baseline dopant-modulated Si system because segment doping is used to control the selective etch process, a situation that places undesirable constraints on geode design. Thus, the synthesis of geodes containing nanowires with a combination of Si and Ge segments can be done. In this system, the Si and Ge offer process orthogonality—Ge segments can be readily etched in H₂O₂ to create grooves (that dictate UV/visible response) while heavily doped Si segments (to control IR plasmonic response) are resistant to H₂O₂.

### Understanding the Optical Response of Individual Geodes

To understand the optical response at the largest scale of the system (assemblies of geodes) the response of an individual geode should be understood, which in turn depends on the response of the component nanowires and microcapsule. The calculated optical response for a geode can then be input into the calculation for microsphere packings. Models of the response of an individual geode are based on Mie theory for nanowires and microcapsules but will also account for the couplings between resonances.

Both approximate calculations and discrete simulations can be employed to calculate the optical properties of individual geodes. In the simplest approach, the response of the nanowires and microcapsules can be calculated separately to approximate the total response by combining the two. Next, the nanowires inside the microcapsules are treated as an effective medium, with a dielectric function determined by the density of nanowires (which can have a radial dependence) and their individual scattering and absorption cross-sections. In this mean-field approach, the cross-sections can be calculated directly from Mie theory for a layered sphere. The results from these approaches can be compared to numerical simulations in which the interaction of light with a discretized model of the entire geode is modeled. The use of finite-element methods, which are accurate and can account for large differences in scale (for example, between the size of the microcapsule and the modulations in the nanowire diameter in FIG. 5B with a non-uniform mesh, can be conducted.

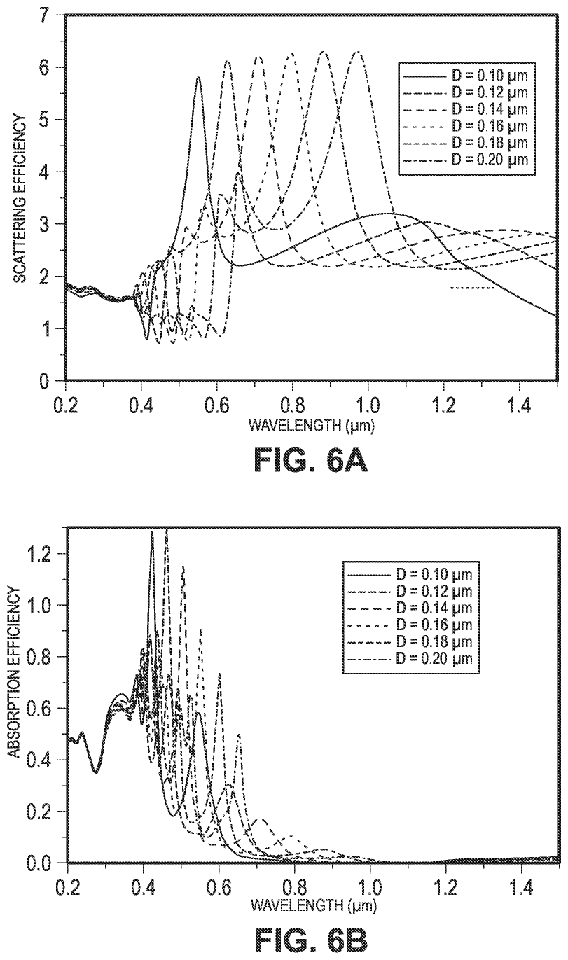

FIGS. 6A and 6B are plots depicting simulation of scattering and absorption efficiency spectra, respectively, for infinite Si nanowires of ˜10²⁰ cm⁻³ doping, in accordance with the present disclosure. Calculations illustrate how the nanowire and microcapsule resonances can be programmed FIGS. 6A and 6B show Mie theory calculations for the absorption and scattering efficiencies, respectively, of Si nanowires of diameters d=0.1-0.2 mm. The Si nanowires exhibit strong resonance peaks in scattering efficiency, which are significantly greater than unity (˜6). The dependence of the peak position on the nanowire diameter is clear, indicating precise controllability of the scattering spectrum. The absorption efficiency shows sharp peaks that also shift as the diameter changes. Because of the indirect bandgap of Si, the absorption efficiency peaks become gradually weaker as the wavelength of incident light increases from UV towards the bandgap wavelength (˜1.1 mm).

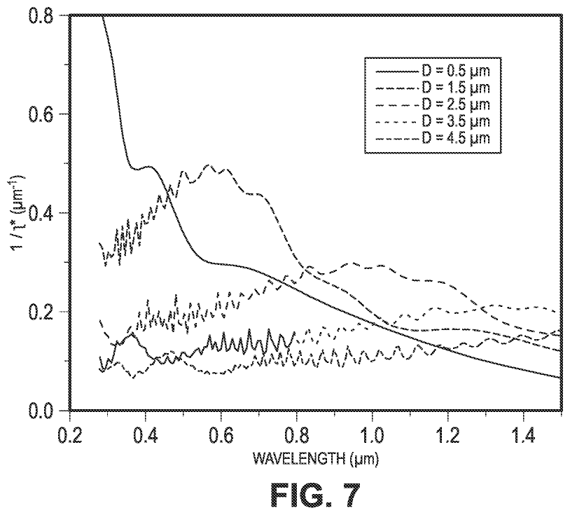

FIG. 7 is a plot depicting a simulation of scattering strength of hollow microspheres in a dielectric material with n=1.5 and at a volume fraction of 0.5, where D represents sphere diameter, in accordance with the present disclosure. FIG. 7 shows the scattering strength as a function of wavelength calculated for monodisperse hollow microspheres embedded in a matrix of refractive index n=1.5. D is the diameter of the hollow microspheres and the material volume fraction is 0.5. l* is the transport length (see Section 4.3), and 1/l* quantifies the scattering power of the material. As D increases, a 1/l* peak shifts to larger wavelengths and becomes very broad.

To a first approximation, the behavior of light scattering/absorption of geodes in a matrix is a combined effect of the nanowire (FIGS. 6A and 6B) and microcapsule (FIG. 7) resonances. For large microcapsules, it can be expected that the strength of the nanowire resonances will be modulated by the spectrally-broader scattering of the microcapsules. For small microcapsules (2 μm and below), there is significant overlap, and coupling will be significant. It is therefore expected that a variety of reflectance spectra can be obtained from the interplay between the structural elements of the geodes.

Finite-element simulations based on structures and parameters (density of nanowires, size of geode, etc.) from synthesis can be conducted. These results of these simulations can be compared to calculations using the approximate approaches in order to gauge the validity of the approximations. Where the approximations are valid, they will be used in the next two aims: understanding the response of assemblies of geodes and exploring the parameter space. The geodes will be synthesized, and the optical properties will be characterized and compared to predictions from the model. A microscope-based spectrometer that can measure the visible spectra of individual particles will be used, thus precluding any multiple scattering. A diffuse reflectance setup that can measure spectra from 400 nm to 50 μm will be utilized. To probe the full response, from the UV to mid-IR with a well-calibrated setup, instrumentation having a range of 200 nm to 20 μm which is temperature-controlled can be used. For these bulk measurements, dilute and/or thin powder samples of geodes are used to minimize multiple scattering.

### Understanding the Optical Response of Assemblies of Geodes

To model the response of assemblies of geodes, the model for the optical properties of geodes is incorporated into models for multiple scattering and interference. Two approaches, including radiative-transfer theory and Monte Carlo simulations, are used. Both approaches take as input the phase function (angular scattering) and cross sections of individual geodes, and both make use of effective-medium (mean-field) theory.

With a radiative-transfer approach, light propagation in homogeneous random media can be described by the radiative transfer equation (RTE). The RTE is obtained from energy balance of scattered light intensity as:

$$\hat{s} \cdot ∇ {I}_{d} ( r , \hat{s} ) = - ρ {σ}_{t} ( \hat{s} ) {I}_{d} ( r , \hat{s} ) + \frac{ρ}{4 π} {\int }_{4 π} p ( \hat{s} , {\hat{s}}^{′} ) {σ}_{t} ( {\hat{s}}^{′} ) {I}_{tot} ( r , {\hat{s}}^{′} ) d {ω}^{′} \qquad ( 1 )$$

where ŝ and ŝ′ are unit direction vectors, r is the position vector, I_{d} is the diffuse specific intensity, ρ is the number density of scatterers, sₜ is the extinction cross section, Iₜₒₜ is the total specific intensity, dω′ is the differential solid angle in the ŝ′ direction, and p(ŝ, ŝ′) is the phase function representing the probability density that light incident in the ŝ′-direction is scattered into the ŝ-direction. Equation (1) states that the ŝ-direction gradient in I_{d} (left hand side) is due to the scattering of I_{d} out of the ŝ-direction (ρsₜ I_{d} term) and the scattering of the total intensity from all other directions into the ŝ-direction (integral term). Within the radiative transfer model, light propagation is characterized by the extinction cross section (sₜ), the phase function (ρ), and the scatterer density (ρ). Transmittance/reflectance/absorptance of a random media film are obtained by solving the RTE. The RTE can be simplified by the diffusion approximation, which assumes that I_{d} is slowly varying over the space. The resulting diffusion equation provides an analytical solution for transmittance/reflectance/absorptance for a film.

The materials described previously can be characterized in terms of two lengths: transport mean free path (l*) and diffusive absorption mean free path (l_{da}). l* is the length over which the direction of light propagation is randomized, and l_{da} represents a length that diffusing light travels before being significantly absorbed. These lengths are obtained in terms of the RTE parameters by

$$\frac{1}{{l}^{*}} = ρ {σ}_{t} ( 1 - \frac{1}{4 π} {\int }_{4 π} p ( \hat{s} \cdot {\hat{s}}^{′} ) \hat{s} \cdot {\hat{s}}^{′} d {ω}^{′} ) and \frac{1}{{l}_{da}} = ρ {σ}_{a} , \qquad ( 2 )$$

where sₐ=sₜ−sₛ is the absorption cross section with sₛ being the scattering cross section. l* and l_{da} will be obtained by fitting experimentally measured transmittance and absorptance at different thicknesses to the solutions to the RTE or the diffusion equation. Alternatively, they can be determined from coherent backscattering measurement. When the random material is lossless, for a film of a thickness L>>l*, transmittance is roughly ˜l/L. When absorption is present, transmittance scales with thickness as exp(−kL), where k²=3(l*·l_{da}).

The terms l* and l_{da} can be calculated using mean-field theory, which is in general highly accurate in calculating scattering properties of optically dense media. Specifically, scattering units embedded in an effective medium are considered. For example, for randomly stacked non-overlapping monodisperse solid microspheres, the scattering units are a core-shell particle and an air volume. In the core-shell particle, the core is a solid microsphere and the shell is air; the air volume is a representative volume between the microspheres. In the mean-field approach, l* and l_{da} of each scattering unit are calculated based on the Mie theory by taking an average scattering amplitude based on the volume fraction of each scattering unit.

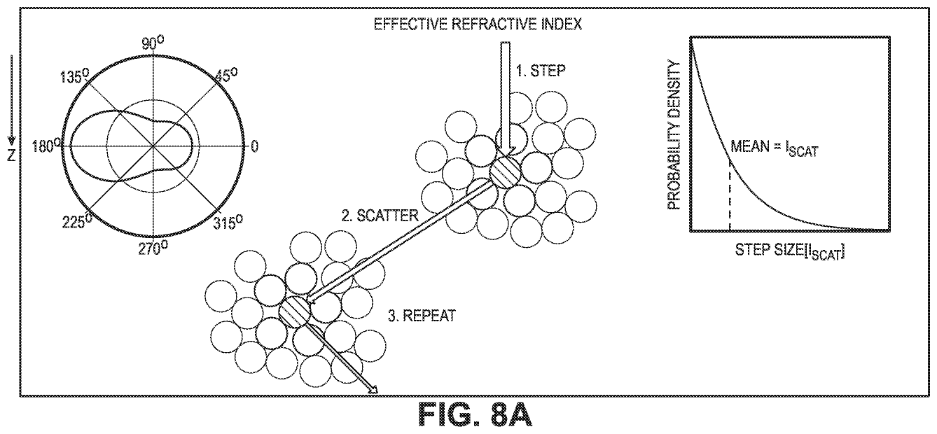

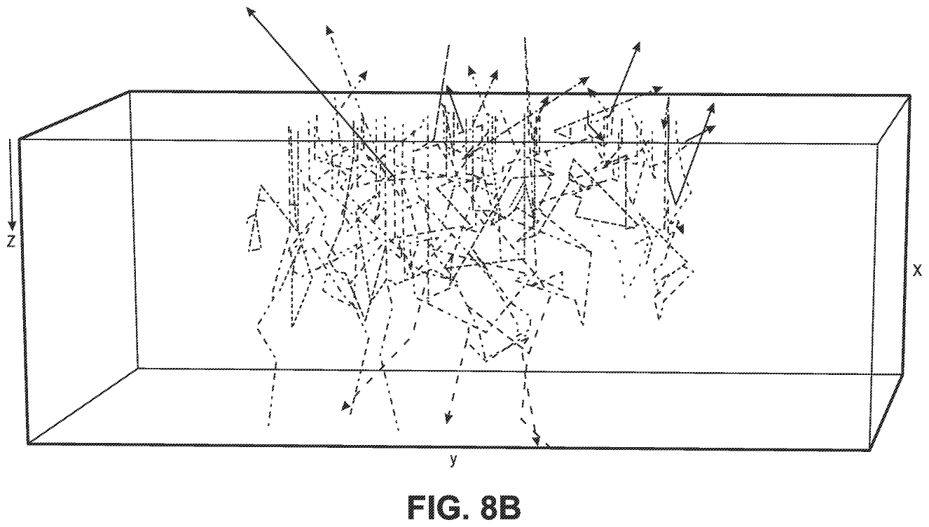

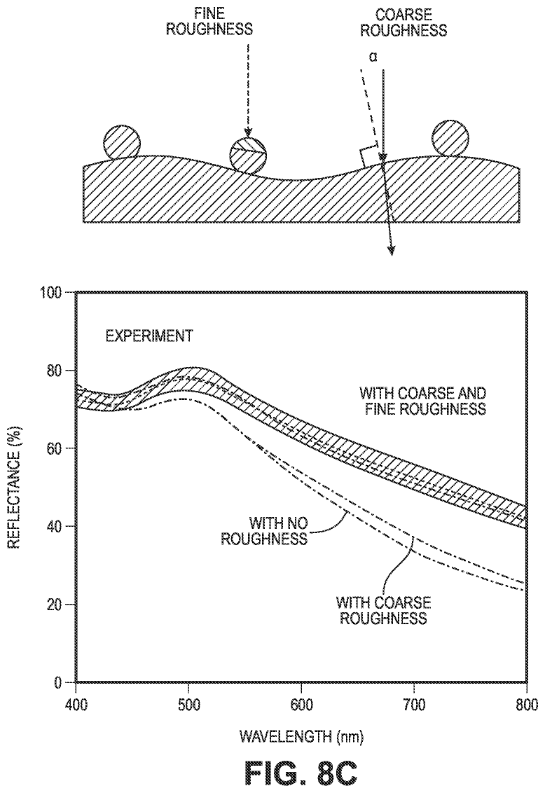

FIGS. 8A-8C depict a Monte Carlo approach for modeling optical response of assemblies of geodes, where FIG. 8A depicts a diagram of simulation, showing trajectory of a photon packet, phase function, and step size distribution, FIG. 8B depicts a rendering of trajectories from a simulation of disordered 200 nm polystyrene spheres, and FIG. 8C is a diagram of roughness scales and plot showing agreement between model and experiment when roughness is accounted for, in accordance with the present disclosure. The Monte Carlo approach is a type of radiative-transfer approach, but one in which the transfer is modeled as a set of discrete absorption or scattering events. The trajectories of thousands of “photon packets” are simulated as they scatter in the material and either emerge or are absorbed. This approach does not require the use of the diffusion approximation and is therefore useful even for thin samples. It also permits the use of phase functions that account for structural correlations and interference. The approach relies on the same mean-field approximation as the RTE approach; however, it is more computationally intensive.

The Monte Carlo approach is based on a scattering model. It is assumed that light interacts with randomly packed spherical particles. the differential cross-section as the product of a form factor F is calculated, which accounts for the scattering from individual particles and is calculated from Mie theory, and a structure factor S, which accounts for interference between waves scattered from different particles and is calculated using the Percus-Yevick approximation for the structure factor: dσ/dΩ=FS. The spheres are embedded in an effective medium whose refractive index comes from the Bruggeman approximation. This differential scattering cross section is used as input to the Monte Carlo simulation.

At each step in the simulation, photon packets move a random distance, sampled from an exponential distribution whose mean is the scattering length l_{scat}=1/ρσ. After each step, they scatter into a random direction sampled from the phase function P(θ)=(dσ/dΩ)/σ. When any of the materials has a complex refractive index, the appropriate Mie solutions are calculated for absorbing materials. As the photons travel, their weights are reduced according to Beer's law, where l_{scat} is replaced with the absorption length. The diffuse reflectance is then calculated by counting the trajectories that are scattered into the backward hemisphere. This simulation framework and results are illustrated in FIGS. 8A and 8B. It has been demonstrated that the model produces quantitative agreement with measurements over a wide parameter range, once interfacial roughness is accounted for as shown in FIG. 8C.

Although previous studies show that the mean-field approach is a good approximation, even for dense and highly scattering samples, it is essential to account for the breakdown of mean-field theory at the boundary of the sample. When reflectance is calculated by solving Maxwell's equations on a supercell of the media, the interface effect is directly accounted for. But because such a direct calculation is computationally expensive, it is not practical, especially when calculations for many different design variables are required. Therefore, models of scattering from the interfaces of the samples should be developed and tested. These models also depend on the sample composition.

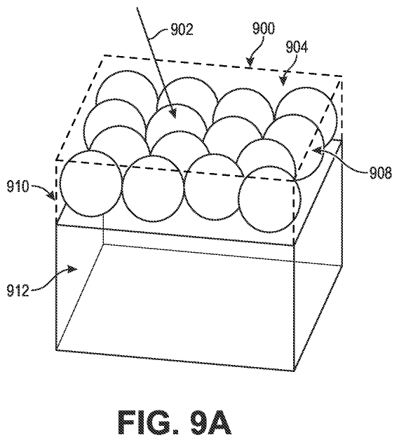

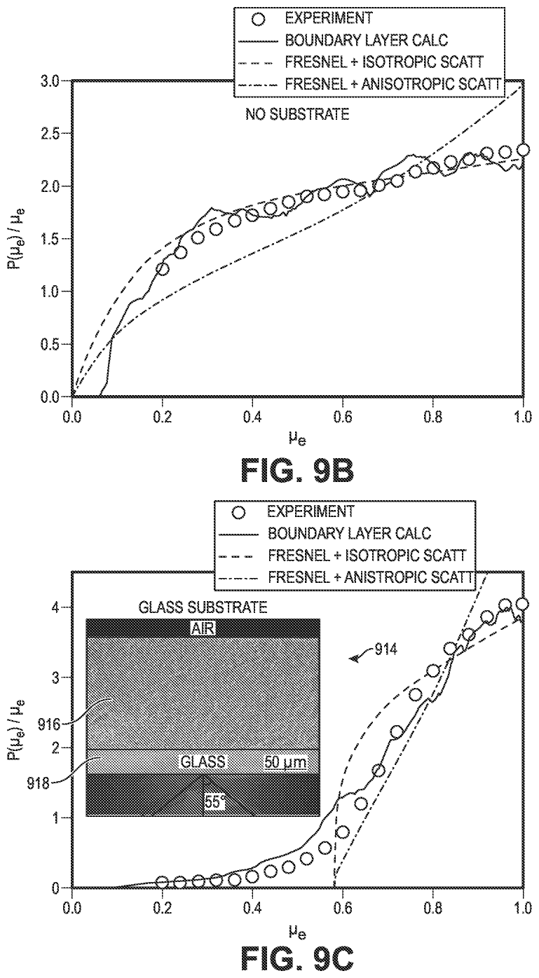

FIG. 9A depicts an illustration of the optical boundary layer model for the top interface of assembled geodes, while FIGS. 9B-9C depict the angular distribution of light transmitted through a photonic glass 900 and scattered into air (or polymer) 904 and borosilicate glass, respectively, in accordance with the present disclosure. The data shown in FIGS. 9B and 9C are obtained from experiment (circle), optical boundary layer calculations (solid line), and Fresnel's law with isotropic (dashed line) and anisotropic (dash-dotted line) scattering. The photonic glass consists of randomly packed 2-μm-diameter silica microspheres, and the incident wavelength is 654 nm. At the bottom of FIG. 9C, inset 914, is a picture of transmitted light emerging from hemi-spherical glass 916 attached to the glass substrate 918, showing appreciable intensities over Fresnel-forbidden angles cos⁻¹μₑ>55°.

A theory is applied to model optical interaction at an interface of random media. Here Fresnel transmission/reflection at a boundary layer 910 of scattering media, geodes 908, is replaced by scattering within a finite region near the boundary defined as the optical boundary layer (OBL). In the air or polymer 904 super cell, incident light 902 is measured when transmitted through an optical boundary layer 910 and into/through an effective medium 912. The validity of the OBL theory was tested in experiment. FIGS. 9B and 9C show that the OBL theory results (line) match well with experiment (circles) for angular distribution of transmitted light.

The OBL is used in concert with radiative-transfer theory to calculate reflectance and absorptance of assemblies of geodes for both top and bottom interfaces. The OBL calculation is integrated into the Monte Carlo method, in addition to the roughness calculation. To reduce computational time, the OBL approach can be simplified for material systems where optical interference effects can be ignored. In this case, light intensity reflected from the OBL into air and that transmitted from the effective medium through the OBL into air can be added and divided by the incident intensity to obtain reflectance.

### Determining the Fundamental Limits on Optical Response

The outcome of the experiments described above will be a set of multiscale models that can accurately predict the properties of any geode assembly. With such a model, the following three high-level aims can be pursued:

Exploring the parameter space and fundamental limits. It is important to understand which optical properties are and are not possible. To do this Bayesian optimization can be used to target specific desired extremal properties, such as complete visible transparency and complete UV opacity, or complete visible opacity and complete IR absorbance. An objective function is used such as a squared error over a broad spectrum. A large squared error suggests that some spectra cannot be accessed. It is important to understand the physical reasons for these limitations. Previous work has shown that this approach can lead to new physical understanding, which is useful in guiding the design of materials. For example, with solid microspheres, theory shows red hues cannot be accessed, owing to the tendency of solid microspheres to backscatter light more strongly in the blue. Based on this theory, a scheme of using hollow microspheres to generate red structural colors, has been devised and successfully implemented. A similar approach for the geode system can be utilized. Without seeking a general theory that would explain all possible limitations, instead, a simple and explanatory models that explain a specific limit or tradeoff is desired. The theoretical framework for setting the limit in such complex systems would be applicable to other systems as well and could suggest ways to circumvent the limitation (for example, changing the nanowire material).

Inverse design. The optimization approach also allows solving the inverse problem: for a given target response, determine the structure that can come closest to that response. An advantage of the radiative transfer/Monte Carlo multiscale modeling approach is that it is straightforward to incorporate constraints on what can be fabricated, because the models are specified in terms of experimental variables such as the volume fraction of geodes and the density of nanowires (note that this is not true of models such as finite-difference time-domain simulations). This approach will be used for proof-of-concept studies described herein.

Discovering novel properties. The determination of what unconventional optical responses lie within the design space is useful—for example, absorption enhanced by multiple scattering, or novel broadband properties arising from the coupling between resonances. Two areas are of interest: (i) geodes that are a few micrometers in size, in which case the capsule resonances may couple strongly to the nanowire resonances, and both interference and multiple scattering will be significant; and (ii) assemblies of different types of geodes (e.g., differing in capsule diameter or nanowire morphology).

### Composite Materials Integration and Proof-of-Concept

Proof-of-concept studies are provided herein. The aim is to develop methods for assembling geodes and incorporating them into functional materials. This effort begins with experimentally characterizing optical properties (i.e., absorptance, transmission, and reflectance) of randomly packed hollow microspheres and then geodes, without matrix integration, to extract transport mean free path and diffusive absorption mean free path of the assembly. These optical measurements help identify and trace the source of resonant reflectance and absorptance peaks. The experimental measurements are then compared with computational modeling, which will either confirm robustness of the computational models or provide more accurate model parameters.

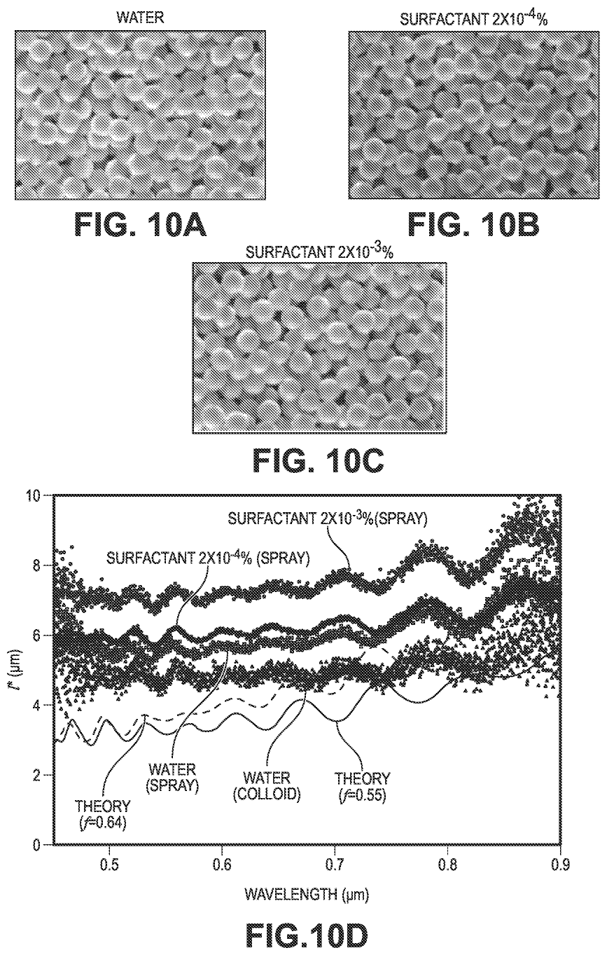

FIGS. 10A-10C are SEM images of D=2 μm silica microspheres deposited by spray coating when the surfactant concentration is 0%, 2×10⁻⁴%, and 2×10⁻³%, respectively, where the scale bar represents 20 μm. FIG. 10D is a plot depicting an l* spectrum for the 3 cases, where solid lines show theoretical values and dots show experimental values, in accordance with the present disclosure. Experimental results show that experimental deposition conditions can significantly affect the optical properties. FIGS. 10A-10C show SEM images of the top surfaces of spray-deposited samples with different surfactant concentrations. The SiO₂ microsphere arrangement appears to be quite random in all three images. However, as shown in FIG. 10D, measurements reveal that l* increases as the surfactant concentration increases. At visible wavelengths, l* increases by ˜1.7 μm when 2×10⁻³% of surfactant is added. Thus, the deposition conditions affect the microsphere arrangement in a way that is evidenced by the change in l* but is not clearly seen in the SEM images. This exhibits the importance of characterizing the mean free path in assembled structures. It also shows that assembly conditions can be used to control the optical properties.

For alternate matrix integration, polymers, such as polyvinylidene difluoride (PVDF) and silicone may be used. The refractive index of PVDF (n˜1.4) and silicone (n˜1.4) and their optical transparency are important considerations. The requirements include (1) a matrix material that is compatible with or resistant to various terrestrial/extraterrestrial environmental stressors (e.g., UV, dust, temperature cycling, high-energy radiation) and (2) a facile geode incorporation process (i.e., easy mixing and even distribution) to enable large volume production. PVDF and silicone to meet many of these requirements. For ease of integration, low-viscosity PVDF solution and silicone monomers (before initiating polymerization) can be used to infiltrate the space between microspheres under vacuum and by capillary force. A planetary mixer can be used to homogenize the microsphere distribution in a polymer matrix.

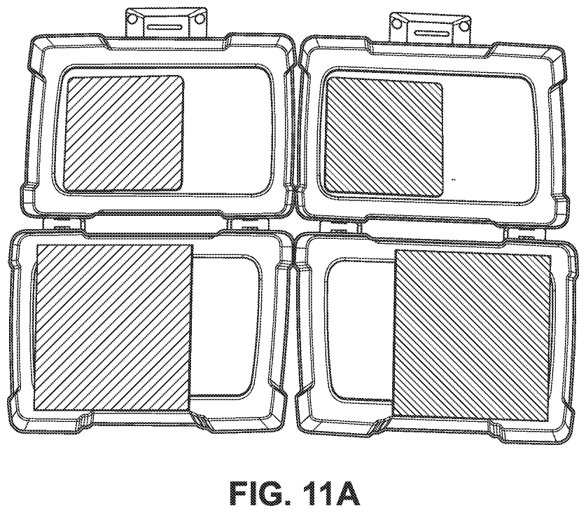

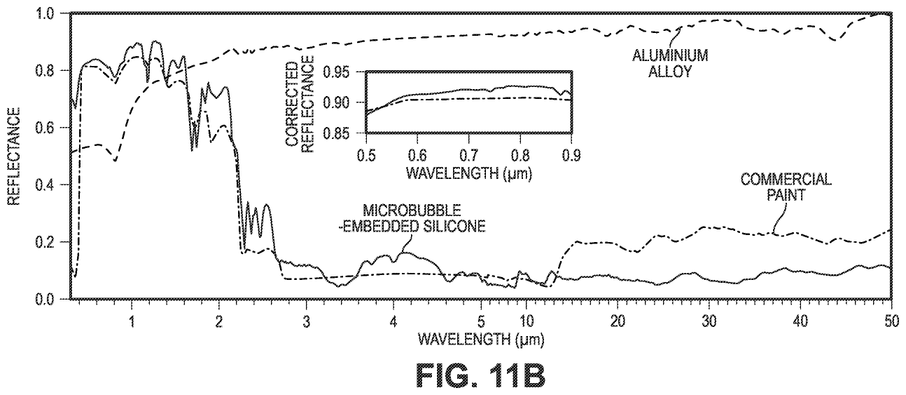

FIG. 11A is an image depicting the incorporation of hollow microspheres into polymer matrices while FIG. 11B is a plot of a reflectance spectrum of a silicone coating embedded with hollow styrene acrylic polymer microspheres (solid line), commercial solar rejection paint (dashed line), and 6061 aluminum alloy (dash dotted line). The microsphere/silicone composite and commercial paint are coated on a black substrate. An inset plot shows the reflectance of composite measured using a single beam in an integrating sphere after error corrections. FIG. 11A demonstrates the feasibility of incorporating hollow microspheres, perform optical characterization, and prototype proof-of-concept designs. FIG. 11B shows that these microsphere/silicone composite coatings provide greater reflectance (from UV to near-IR) than a top-performing commercial solar rejection paint, such as Spartacryl PM® 60312, Chromoflo Technologies. This high reflectance is achieved with a hollow microsphere fill fraction of only ˜0.23. Based on previous modeling, as the fill fraction increases from 0.23 to 0.55 (loose random packing limit), solar average scattering power will increase by a factor of 2.

For UV-protective coatings and spectrally tuned/tunable camouflage, the emergent cooperative optical properties of geodes could prove particularly advantageous. While the technique to integrate geodes into a polymer matrix would remain the same, geodes with strong UV absorption by capsule/nanowire resonance can be used for UV protection. Multiple scattering could then enhance the absorption in the UV. The geode capsule size can also be tuned to minimize visible scattering and thus maximize transmission in the visible. For spectrally tuned/tunable camouflage, the creation of geode/polymer composites with absorption bands selectively appearing in UV, visible, and/or IR, decoupled from high-reflectance spectral regions due to bulk light scattering can be employed. As an example, geode/polymer composites with high reflectance in IR with visible colors rendered by absorption due to capsule/nanowire resonance can be utilized.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An optically responsive material, comprising:
a composite matrix; and
a plurality of colloidal nanowire geodes arranged within the composite matrix; and
wherein the optically responsive material has an optical resonance in at least one spectral region.

2. The optically responsive material of claim 1, wherein the composite matrix comprises a polymer.

3. The optically responsive material of claim 2, wherein the polymer is polyvinylidene fluoride.

4. The optically responsive material of claim 1, wherein each of the plurality of colloidal nanowire geodes further comprises:
a hollow colloidal microsphere; and
a nanowire coupled to an inner surface of the hollow colloidal microsphere.

5. The optically responsive material of claim 4, wherein the plurality of colloidal nanowire geodes is present in an amount from about 0.5% to about 30% based on a total weight of the optically responsive material.

6. The optically responsive material of claim 4, wherein the hollow colloidal microsphere comprises silicon dioxide.

7. The optically responsive material of claim 4, wherein the hollow colloidal microsphere comprises silicon nitride.

8. The optically responsive material of claim 4, wherein the nanowire comprises a semiconductor material.

9. The optically responsive material of claim 4, wherein the nanowire comprises silicon, phosphorous, boron, germanium, or a combination thereof.

10. The optically responsive material of claim 4, wherein the nanowire is doped with one or more impurities to modify a dielectric property of the colloidal nanowire geodes.

11. The optically responsive material of claim 4, wherein the nanowire is selectively etched to scatter light in one or more spectral regions.

12. The optically responsive material of claim 1, wherein each of the plurality of colloidal nanowire geodes has an optical resonance in the ultraviolet spectral region.

13. The optically responsive material of claim 1, wherein each of the plurality of colloidal nanowire geodes has an optical resonance in the infrared spectral region.

14. The optically responsive material of claim 1, wherein each of the plurality of colloidal nanowire geodes has an optical resonance in the visible spectral region.

15. The optically responsive material of claim 1, wherein the optically responsive material has an optical resonance in the ultraviolet spectral region, the infrared spectral region, the visible spectral region, or a combination thereof.

16. A colloidal nanowire geode, comprising:
a hollow colloidal microsphere; and
a nanowire coupled to an inner surface of the hollow colloidal microsphere.

17. The colloidal nanowire geode of claim 16, wherein the colloidal nanowire geode has an optical resonance in at least one spectral region.

18. The colloidal nanowire geode of claim 17, wherein the colloidal nanowire geode has an optical resonance in the ultraviolet spectral region, the infrared spectral region, the visible spectral region, or a combination thereof.

19. The colloidal nanowire geode of claim 16, wherein the hollow colloidal microsphere comprises silicon dioxide.

20. The colloidal nanowire geode of claim 16, wherein the hollow colloidal microsphere comprises silicon nitride.

21. The colloidal nanowire geode of claim 16, wherein the nanowire comprises a semiconductor material.

22. The colloidal nanowire geode of claim 16, wherein the nanowire comprises silicon, phosphorous, boron, germanium, or a combination thereof.

23. The colloidal nanowire geode of claim 16, wherein the nanowire is doped with one or more impurities to modify a dielectric property of the colloidal nanowire geodes.

24. The colloidal nanowire geode of claim 16, wherein the nanowire is selectively etched to scatter light in one or more spectral regions.

25. A method of fabricating optically responsive materials, comprising:
emulsifying a plurality of microscapsules from a hydrophobic silica in the presence of a hydrophilic metal nanoparticle in a water-in-oil media in a first emulsification process;
emulsifying the plurality of microscapsules further in a water-in-oil-in-water media in a second emulsification process to produce a double emulsion;
diluting the double emulsion to extract an oil portion of the double emulsion into a water phase to create a plurality of consolidated, porous microcapsule suspension;
drying the suspension to produce a plurality of hollow microcapsules having metal nanoparticles disposed onto an interior surface of the plurality of hollow microcapsules; and
depositing a nanowire onto the one or more metal nanoparticles to initiate and grow a plurality of nanowires disposed onto the interior surface of the plurality of hollow microcapsules.

26. The method of fabricating optically responsive materials of claim 25, further comprising selectively etching the plurality of nanowires to tune an optical resonance in at least one spectral region.

27. The method of fabricating optically responsive materials of claim 25, further comprising filling one or more pores in an exterior surface of the plurality of microscapsules by atomic layer deposition.

28. The method of fabricating optically responsive materials of claim 25, wherein the plurality of nanowires comprises silicon, phosphorous, boron, germanium, or a combination thereof.

29. The method of fabricating optically responsive materials of claim 25, wherein the plurality of nanowires are doped with one or more impurities to modify a dielectric property of the plurality of nanowires.

30. The method of fabricating optically responsive materials of claim 25, wherein the hydrophilic metal nanoparticles comprises gold.

31. A method of programming optically responsive materials, comprising:
inputting one or more structural parameters of a colloidal nanowire geode into a finite-element model simulation to predict an optical response result of the colloidal nanowire geode;
synthesizing a colloidal nanowire geode according to the inputted structural parameters;
measuring optical properties of the colloidal nanowire geode; and
comparing the measured properties of the colloidal nanowire geodes to the predicted optical response result.

32. The method of programming optically responsive materials of claim 31, wherein the finite-element model simulation comprises a radiative-transfer approach.

33. The method of programming optically responsive materials of claim 31, wherein the finite-element model simulation comprises a Monte Carlo approach.
